(19) United States
(12) Patent Application Publication
(10) Pub. No.: US 2006/0067346 A1
(43) Pub. Date: Mar. 30, 2006

(54) System and method for placement of RDMA payload into application memory of a processor system

(75) Inventors: Tom Tucker, Austin, TX (US); Yantao Jia, Stow, MA (US)

Correspondence Address: WILMER CUTLER PICKERING HALE AND DORR LLP, 60 STATE STREET, BOSTON, MA, 02109, US

(73) Assignee: Ammasso, Inc.

(21) Appl. No.: 10/916,126

(22) Filed: Aug. 11, 2004

Related U.S. Application Data
(60) Provisional application No. 60/559,557, filed on Apr. 5, 2004.

(51) Int. Cl. H04L 12/56

(52) U.S. Cl. 370/412

(57) ABSTRACT

A system and method for placement of RDMA payload into application memory of a processor system. Under one embodiment, a network adapter system is capable of use in network communication in accordance with a direct data placement (DDP) protocol, e.g., RDMA. The network adapter system includes adapter memory and a plurality of placement records in the adapter memory. Each placement record specifies per-connection placement data including at least network address information and port identifications of source and destination network entities for a corresponding DDP protocol connection. Placement record identification logic uniquely identifies a placement record from network address information and port identification information contained in a DDP message received by the network adapter system. Untagged message payload placement logic directly places the payload of the received untagged DDP message into physical address locations of host memory corresponding to one of said connection-specific application buffers. Tagged message payload placement logic directly places the payload of the tagged DDP message into physical address locations of host memory corresponding to the identifier in the received DDP message. According to one embodiment, the placement records are organized as an array of hash buckets with each element of the array containing a placement record and each placement record containing a specification of a next placement record in the same bucket. The placement record identification logic includes hashing logic to create a hash index pointing to a bucket in the array by hashing a 4-tuple consisting of a source address, a destination address, a source port, and a destination port contained in the received DDP message.

### CROSS-REFERENCE TO RELATED APPLICATIONS

This application claims priority under 35 U.S.C. §119(e) to U.S. Provisional Patent Application No. 60/559,557, filed on Apr. 5, 2004, entitled SYSTEM AND METHOD FOR REMOTE DIRECT MEMORY ACCESS, which is expressly incorporated herein by reference in its entirety.

This application is related to U.S. patent application Nos. <to be determined>, filed on even date herewith, entitled SYSTEM AND METHOD FOR WORK REQUEST QUEUING FOR INTELLIGENT ADAPTER and SYSTEM AND METHOD FOR PLACEMENT OF SHARING PHYSICAL BUFFER LISTS IN RDMA COMMUNICATION, which are incorporated herein by reference in their entirety.

### BACKGROUND

1. Field of the Invention

This invention relates to network interfaces and more particularly to the direct placement of RDMA payload into processor memory.

2. Discussion of Related Art

Implementation of multi-tiered architectures, distributed Internet-based applications, and the growing use of clustering and grid computing is driving an explosive demand for more network and system performance, putting considerable pressure on enterprise data centers.

With continuing advancements in network technology, particularly 1 Gbit and 10 Gbit Ethernet, connection speeds are growing faster than the memory bandwidth of the servers that handle the network traffic. Combined with the added problem of ever-increasing amounts of data that need to be transmitted, data centers are now facing an “I/O bottleneck”. This bottleneck has resulted in reduced scalability of applications and systems, as well as, lower overall systems performance.

There are a number of approaches on the market today that try to address these issues. Two of these are leveraging TCP/IP offload on Ethernet networks and deploying specialized networks. A TCP/IP Offload Engine (TOE) offloads the processing of the TCP/IP stack to a network coprocessor, thus reducing the load on the CPU. However, a TOE does not completely reduce data copying, nor does it reduce user-kernel context switching—it merely moves these to the coprocessor. TOEs also queue messages to reduce interrupts, and this can add to latency.

Another approach is to implement specialized solutions, such as InfiniBand, which typically offer high performance and low latency, but at relatively high cost and complexity. A major disadvantage of InfiniBand and other such solutions is that they require customers to add another interconnect network to an infrastructure that already includes Ethernet and, oftentimes, Fibre Channel for storage area networks. Additionally, since the cluster fabric is not backwards compatible with Ethernet, an entire new network build-out is required.

One approach to increasing memory and I/O bandwidth while reducing latency is the development of Remote Direct Memory Access (RDMA), a set of protocols that enable the movement of data from the memory of one computer directly into the memory of another computer without involving the operating system of either system. By bypassing the kernel, RDMA eliminates copying operations and reduces host CPU usage. This provides a significant component of the solution to the ongoing latency and memory bandwidth problem.

Once a connection has been established, RDMA enables the movement of data from the memory of one computer directly into the memory of another computer without involving the operating system of either node. RDMA supports “zerocopy” networking by enabling the network adapter to transfer data directly to or from application memory, eliminating the need to copy data between application memory and the data buffers in the operating system. When an application performs an RDMA Read or Write request, the application data is delivered directly to the network, hence latency is reduced and applications can transfer messages faster (see FIG. 1).

RDMA reduces demand on the host CPU by enabling applications to directly issue commands to the adapter without having to execute a kernel call (referred to as “kernel bypass”). The RDMA request is issued from an application running on one server to the local adapter and then carried over the network to the remote adapter without requiring operating system involvement at either end. Since all of the information pertaining to the remote virtual memory address is contained in the RDMA message itself, and host and remote memory protection issues were checked during connection establishment, the remote operating system does not need to be involved in each message. The RDMA-enabled network adapter implements all of the required RDMA operations, as well as, the processing of the TCP/IP protocol stack, thus reducing demand on the CPU and providing a significant advantage over standard adapters (see FIG. 2).

Several different APIs and mechanisms have been proposed to utilize RDMA, including the Direct Access Provider Layer (DAPL), the Message Passing Interface (MPI), the Sockets Direct Protocol (SDP), iSCSI extensions for RDMA (iSER), and the Direct Access File System (DAFS). In addition, the RDMA Consortium proposes relevant specifications including the SDP and iSER protocols and the Verbs specification (more below). The Direct Access Transport (DAT) Collaborative is also defining APIs to exploit RDMA. (These APIs and specifications are extensive and readers are referred to the relevant organizational bodies for full specifications. This description discusses only select, relevant features to the extent necessary to understand the invention.)

FIG. 3 illustrates the stacked nature of an exemplary RDMA capable Network Interface Card (RNIC). The semantics of the interface is defined by the Verbs layer. Though the figure shows the RNIC card as implementing many of the layers including part of the Verbs layer, this is exemplary only. The standard does not specify implementation, and in fact everything may be implemented in software yet comply with the standards.

In the exemplary arrangement, the direct data placement protocol (DDP) layer is responsible for direct data placement. Typically, this layer places data into a tagged buffer or untagged buffer, depending on the model chosen. In the tagged buffer model, the location to place the data is identified via a steering tag (STag) and a target offset (TO), each of which is described in the relevant specifications, and only discussed here to the extent necessary to understand the invention.

Other layers such as RDMAP extend the functionality and provide for things like RDMA read operations and several types of writing tagged and untagged data.

The behavior of the RNIC (i.e., the manner in which uppers layers can interact with the RNIC) is a consequence of the Verbs specification. The Verbs layer describes things like (1) how to establish a connection, (2) the send queue/receive queue (Queue Pair or QP), (3) completion queues, (4) memory registration and access rights, and (5) work request processing and ordering rules.

A QP includes a Send Queue and a Receive Queue, each sometimes called a work queue. A Verbs consumer (e.g., upper layer software) establishes communication with a remote process by connecting the QP to a QP owned by the remote process. A given process may have many QPs, one for each remote process with which it communicates.

Sends, RDMA Reads, and RDMA Writes are posted to a Send Queue. Receives are posted to a Receive Queue (i.e., receive buffers with data that are the target for incoming Send messages). Another queue called a Completion Queue is used to signal a Verbs consumer when a Send Queue WQE completes, when such notification function is chosen. A Completion Queue may be associated with one or more work queues. Completion may be detected, for example, by polling a Completion Queue for new entries or via a Completion Queue event handler.

The Verbs consumer interacts with these queues by posting a Work Queue Element (WQE) to the queues. Each WQE is a descriptor for an operation. Among other things, it contains (1) a work request identifier, (2) operation type, (3) scatter or gather lists as appropriate for the operation, (4) information indicating whether completion should be signaled or unsignalled, and (5) the relevant STags for the operation, e.g., RDMA Write.

Logically, a STag is a network-wide memory pointer. STags are used in two ways: by remote peers in a Tagged DDP message to write data to a particular memory location in the local host, and by the host to identify a contiguous region of virtual memory into which Untagged DDP data may be placed.

There are two types of memory access under the RDMA model of memory management: memory regions and memory windows. Memory regions are page aligned buffers, and applications may register a memory region for remote access. A region is mapped to a set of (not necessarily contiguous) physical pages. Specified Verbs (e.g., Register Shared Memory Region) are used to manage regions. Memory windows may be created within established memory regions to subdivide that region to give different nodes specific access permissions to different areas.

The Verbs specification is agnostic to the underlying implementation of the queuing model.

### SUMMARY

The invention provides a system and method for placement of RDMA payload into application memory of a processor system.

According to one aspect of the invention, a network adapter system is capable of use in a computer system including a host processor and host memory. The network adapter system is also capable of use in network communication in accordance with a direct data placement (DDP) protocol, in which the DDP protocol specifies tagged and untagged data movement into a connection-specific application buffer in a contiguous region of virtual memory space of a corresponding endpoint computer application executing on said host processor. Tagged data movement includes a tagged message that provides an identifier for said connection-specific application buffer. Untagged data movement includes an untagged message that provides no identifier for said connection-specific application buffer. The network adapter system includes adapter memory and a plurality of placement records in the adapter memory. Each placement record specifies per-connection placement data including at least network address information and port identifications of source and destination network entities for a corresponding DDP protocol connection. Placement record identification logic uniquely identifies a placement record from network address information and port identification information contained in a DDP message received by the network adapter system. Untagged message payload placement logic is responsive to a received untagged DDP message and utilizes first information in a uniquely identified, corresponding placement record to directly place the payload of the received untagged DDP message into physical address locations of host memory corresponding to one of said connection-specific application buffers. Tagged message payload placement logic is responsive to a received tagged DDP message and utilizes second information in a uniquely identified, corresponding placement record to validate the received tagged DDP message and if said message is valid directly places the payload of the tagged DDP message into physical address locations of host memory corresponding to the identifier in the received DDP message.

According to another aspect of the invention, the placement records are organized as an array of hash buckets with each element of the array containing a placement record and each placement record containing a specification of a next placement record in the same bucket. The placement record identification logic includes hashing logic to create a hash index pointing to a bucket in the array by hashing a 4-tuple consisting of a source address, a destination address, a source port, and a destination port contained in the received DDP message.

According to another aspect of the invention, the adapter includes at least one physical buffer list to specify physical address locations of host memory corresponding to the identifier in a received DDP message and to specify physical address locations of host memory for one of said connection-specific application buffers corresponding to a received untagged DDP message.

According to another aspect of the invention, the second information in a placement record includes queue pair identification information corresponding to the steering tag in the tagged DDP message, and protection domain identification information corresponding to the steering tag in the tagged DDP message. The tagged message payload placement logic further utilizes a sequence number in said DDP message to validate the received tagged DDP message.

According to another aspect of the invention, the adapter includes a queue of descriptors for connection-specific application buffers for untagged DDP messages. The descriptors include steering tags provided by software executing on said host processor when a connection is established.

According to another aspect of the invention, a placement record includes a pointer to the queue of descriptors for connection-specific application buffers for untagged DDP messages, and the untagged message payload placement logic generates an index into said queue to identify a descriptor to identify host memory locations into which the DDP message payload is to be directly placed.

According to another aspect of the invention, the queue of descriptors has a specified depth and wherein tagged DDP message includes a sequence number and the index is sequence number MODULO specified depth of queue of descriptors.

According to another aspect of the invention, a single queue of descriptor is used to place the payload of a single untagged DDP message.

According to another aspect of the invention, a single untagged DDP message spans a plurality of network packets.

### BRIEF DESCRIPTION OF THE DRAWING

In the Drawing,

FIG. 1 illustrates a host-to-host communication each employing RDMA NICs;

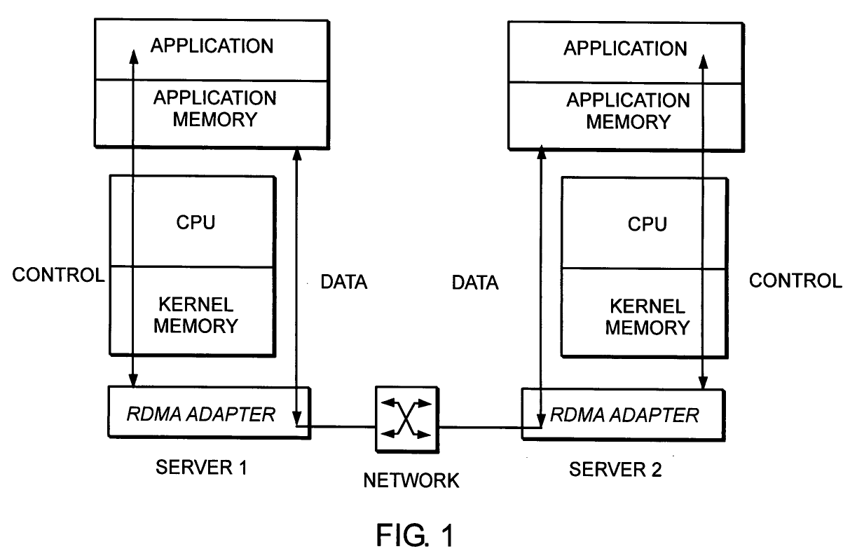

FIG. 2 illustrates a RDMA NIC;

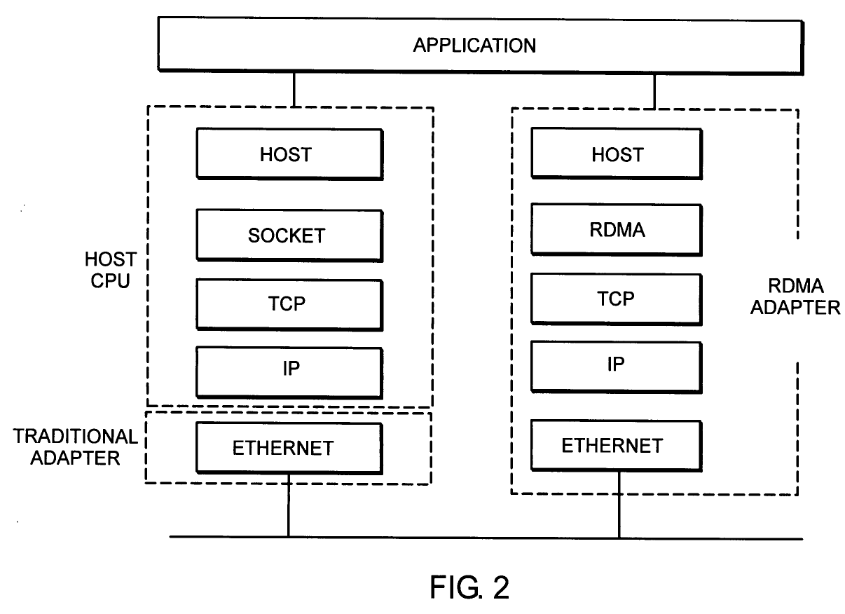

FIG. 3 illustrates a stacked architecture for RDMA communication;

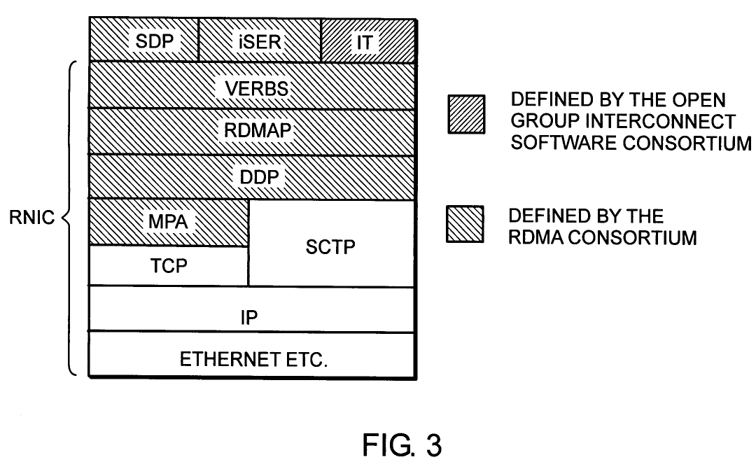

FIG. 4 is a high-level depiction of the architecture of certain embodiments of the invention;

FIG. 5 illustrates the RNIC architecture of certain embodiments of the invention;

FIG. 6 is a block diagram of a RXP controller of certain embodiments of the invention;

FIG. 7 illustrates the organization of control tables for an RXP of certain embodiments of the invention;

FIG. 8 is a host receive descriptor queue of certain embodiments of the invention;

FIG. 9 illustrates the receive descriptor queue of certain embodiments of the invention;

FIG. 10 is a state diagram, depicting the states of the RXP on the reception of a RDMA packet of certain embodiments of the invention;

FIG. 11 illustrates the general format of an MPA PDU;

FIG. 12 illustrates an MPA PDU 1202 broken into two TCP segments;

FIG. 13 shows a single TCP segment that contains multiple MPA PDU;

FIG. 14 shows a sequence of three valid MPA PDU in three TCP segments;

FIG. 15 illustrates the organization of data structures of certain embodiments of the invention used to support STags; and

FIG. 16 illustrates how a PBL maps virtual address space of certain embodiments of the invention.

### DETAILED DESCRIPTION

Preferred embodiments of the invention provide a method and system that efficiently places the payload of RDMA communications into an application buffer. The application buffer is contiguous in the application's virtual address space, but is not necessarily contiguous in the processor's physical address space. The placement of such data is direct and avoids the need for intervening bufferings. The approach minimizes overall system buffering requirements and reduces latency for the data reception.

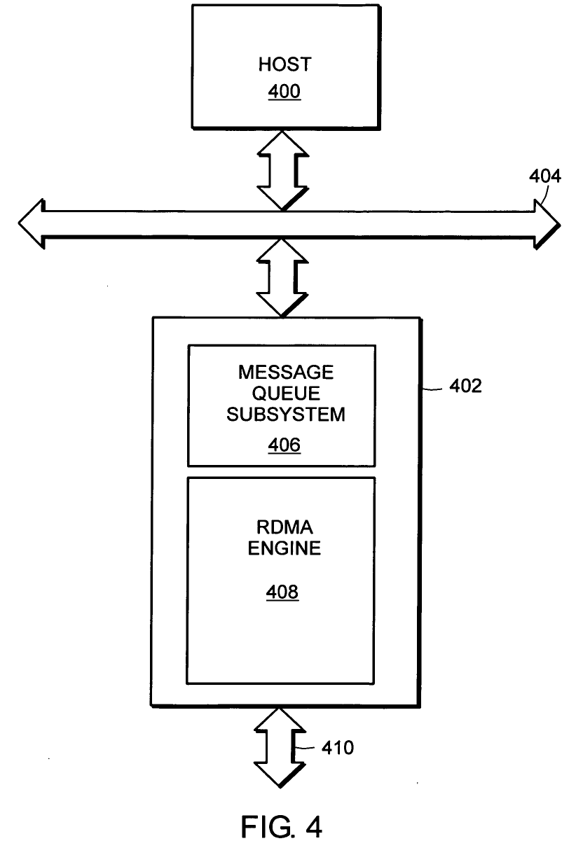

FIG. 4 is a high-level depiction of an RNIC according to a preferred embodiment of the invention. A host computer 400 communicates with the RNIC 402 via a predefined interface 404 (e.g., PCI bus interface). The RNIC 402 includes an message queue subsystem 406 and a RDMA engine 408. The message queue subsystem 406 is primarily responsible for providing the specified work queues and communicating via the specified host interface 404. The RDMA engine interacts with the message queue subsystem 406 and is also responsible for handling communications on the back-end communication link 410, e.g., a Gigabit Ethernet link.

For purposes of understanding this invention, further detail about the message queue subsystem 406 is not needed. However, this subsystem is described in co-pending U.S. patent application No. <to be determined>, entitled SYSTEM AND METHOD FOR WORK REQUEST QUEUING FOR INTELLIGENT ADAPTER and SYSTEM AND METHOD FOR PLACEMENT OF SHARING PHYSICAL BUFFER LISTS IN RDMA COMMUNICATION, filed on even date herewith, which are incorporated herein by reference in their entirety.

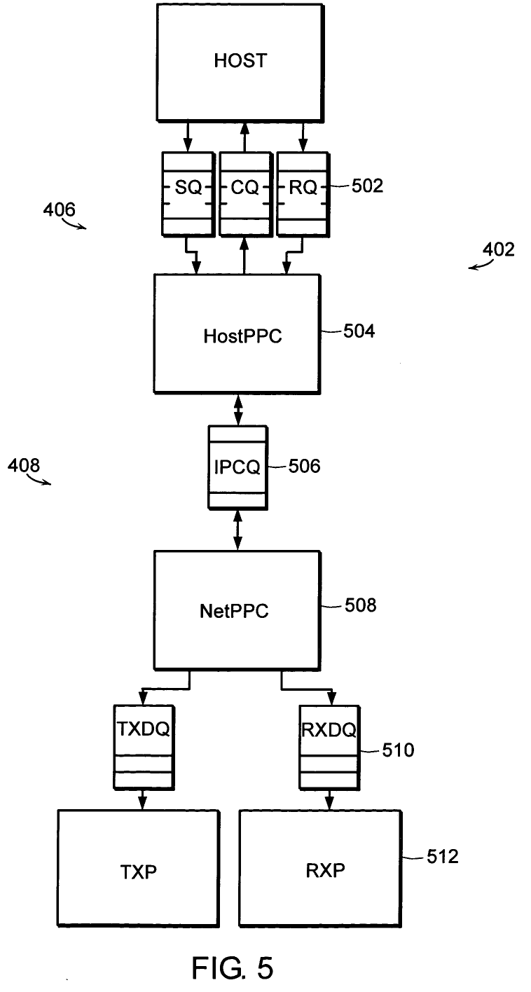

FIG. 5 depicts a preferred RNIC implementation. The RNIC 402 contains two on-chip processors 504,508. Each processor has 16 k of program cache and 16 k of data cache. The processors also contain a separate instruction side and data side on chip memory busses. Sixteen kilobytes of BRAM is assigned to each processor to contain firmware code that is run frequently.

The processors are partitioned as a host processor 504 and network processor 508. The host processor 504 is used to handle host interface functions and the network processor 508 is used to handle network processing. Processor partitioning is also reflected in the attachment of on-chip peripherals to processors. The host processor 504 has interfaces to the host 400 through memory-mapped message queues 502 and PCI interrupt facilities while the network processor 508 is connected to the network processing hardware 512 through on-chip memory descriptor queues 510.

The host processor 504 acts as command and control agent. It accepts work requests from the host and turns these commands into data transfer requests to the network processor 508.

For data transfer, there are three work request queues, the Send Queue (SQ), Receive Queue (RQ), and Completion Queue (CQ). The SQ and RQ contain work queue elements (WQE) that represent send and receive data transfer operations (DTO). The CQ contains completion queue entries (CQE) that represent the completion of a WQE. The submission of a WQE to an SQ or RQ and the receipt of a completion indication in the CQ (CQE) are asynchronous.

The host processor 504 is responsible for the interface to host. The interface to the host consists of a number of hardware and software queues. These queues are used by the host to submit work requests (WR) to the adapter 402 and by the host processor 504 to post WR completion events to the host.

The host processor 504 interfaces with the network processor 508 through the inter-processor queue (IPCQ) 506. The principle purpose of this queue is to allow the host processor 504 to forward data transfer requests (DTO) to the network processor 508 and for the network processor 508 to indicate the completion of these requests to the host processor 504.

The network processor 508 is responsible for managing network I/O. DTO work requests (WRs) are submitted to the network processor 508 by the host processor 504. These WRs are converted into descriptors that control hardware transmit (TXP) and receive (RXP) processors. Completed data transfer operations are reaped from the descriptor queues by the network processor 508, processed, and if necessary DTO completion events are posted to the IPCQ for processing by the host processor 504.

Under a preferred embodiment, the bus 404 is a PCI interface. The adapter 404 has its Base Address Registers (BARs) programmed to reserve a memory address space for a virtual message queue section.

Preferred embodiments of the invention provide a message queue subsystem that manages the work request queues (host→adapter) and completion queues (adapter→host) that implement the kernel bypass interface to the adapter. Preferred message queue subsystems:
1. Avoid PCI read by the host CPU
2. Avoid locking of data structures
3. Support a very large number of user mode host clients (i.e. QP)
4. Minimize the overhead on the host and adapter to post and receive work requests (WR) and completion queue entries (CQE)

With reference to FIG. 5, the processing of receive data is accomplished cooperatively between the NetPPC 508 and the RXP 512. The NetPPC 508 is principally responsible for protocol processing and the RXP 512 for data placement, i.e. the placement of incoming packet header and payload in memory. The NetPPC and RXP communicate using a combination of registers, and memory based tables. The registers are used to configure, start and stop the RXP, while the tables specify memory locations for buffers available to place network data.

Support for standard sockets applications is provided through the native stack. To accomplish this, the adapter looks look like two Ethernet ports to the host. One virtual port (and MAC address) is used for RDMA/TOE data and another virtual port (and MAC address) is used for compatibility mode data. Ethernet frames that arrive at the RDMA/TOE MAC address are delivered via an RNIC Verbs like interface, while frames that arrive at the other MAC address are delivered via a network-adapter like interface.

Network packets are delivered to the native or RDMA interface per the following rules:
Unicast packets to the RDMA/TOE MAC address are delivered to the RDMA/TOE interface
Unicast packets to the Compatibility address are delivered to the compatibility interface
Broadcast packets are delivered to both interfaces
Multicast packets are delivered to both interfaces.

Compatibility mode places network data through a standard dumb-Ethernet interface to the host. The interface is a circular queue of descriptors that point to buffers in host memory. The format of this queue is identical to the queue used to place protocol headers and local data for RDMA mode packets. The difference is only the buffer addresses specified in the descriptor. The compatibility-mode receive queue (HRXDQ) descriptors point to host memory, while the RDMA mode queue (RXDQ) descriptors point to adapter memory.

RDMA/TOE Mode data is provided to the host through an RNIC Verbs-like interface. This interface is implemented in a host device driver.

The NetPPC processor manages the mapping of device driver verbs to RXP hardware commands. This description is principally concerned with the definition of the RXP hardware interface to the NetPPC.

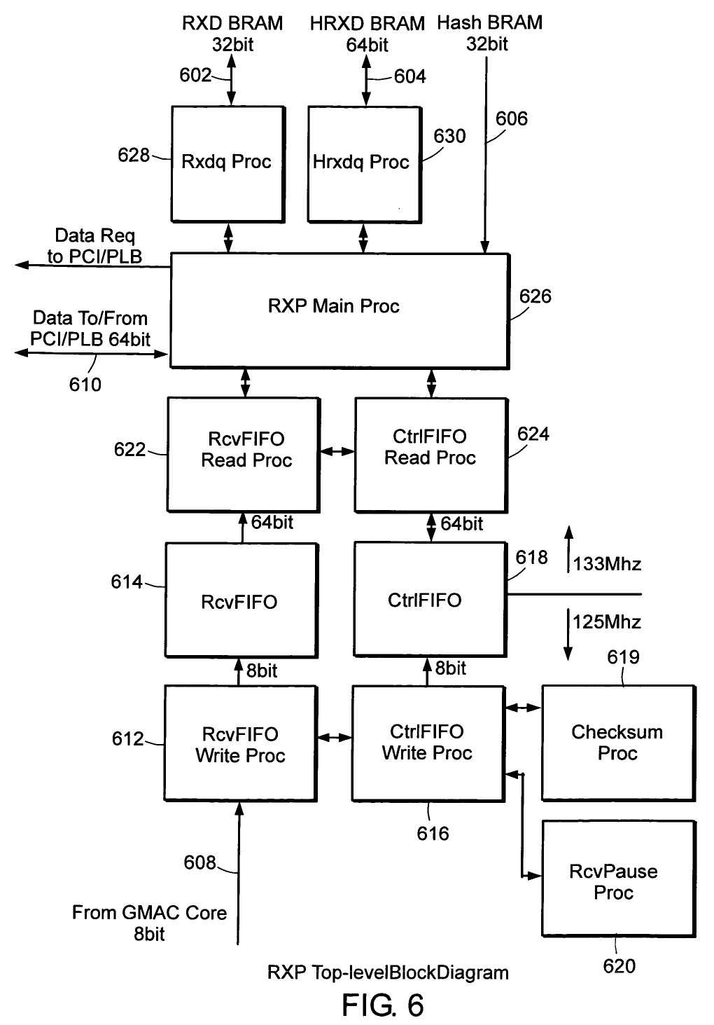

FIG. 6 is a block diagram of the various components of the RXP controller of preferred embodiments. The RXP module has five interfaces:
the RXDQ BRAM interface 602;
the HRXDQ BRAM interface 604;
the HASH table lookup interface 606;
GMAC core interface 608; and
PCI/PLB interface 610.

The RXDQ BRAM 602 interface provides the control and status information for reception of fast-path data traffic. Through this interface, the RXP reads the valid RXD entries formulated by the NetPPC and updates the status after receiving each data packet in fast-path mode.

HRXDQ BRAM interface 604 provides the control and status information for reception of host-compatible data traffic. Through this interface, the RXP reads the valid HRXD entries formulated by the NetPPC and updates the status after receiving each data packet in host-compatible mode.

The hash interface 606 is used in connection with identifying a placement record from a corresponding collection of such. Under certain embodiments a fixed size index is created with each index entry corresponding to a hash bucket. Each hash bucket in turn corresponds to a list of placement records. A hashing algorithm creates an index identification by hashing the 4-tuple of network ip addresses and port identifications for the sender and recipient. The bucket is then traversed to identify a placement record having the corresponding, matching addresses and port identifications. In this fashion, network addresses and ports may be used to time and space efficiently locate a corresponding placement record. The placement records (as will be described below) are used to directly store message payload in host application buffers.

The GMAC core interface 608 receives data 8 bits at a time from the network.

The PCI/PLB interface 610 provides the channel to store received data into host memory and/or local data memory as one or multiple data segments.

The RcvFIFO write process module 612 controls the address and write enable to the RcvFIFO 614. It stores data 8 bits at a time into the RcvFIFO from the network. If the received packet is aborted due to CRC or any other network errors, this module aborts the current packet reception, flushes the aborted packet from RcvFIFO, and resets all receive pointers for next incoming packet. Once a packet is loaded into the data buffer, it updates a packet valid flag to the RcvFIFO read process module

The RcvFIFO 614 is 40 Kbytes deep, and this circular ring buffer is efficient to store maximum number of packets. The 40 Kbytes is needed to store enough maximum packets in case that lossless traffic and flow control are required. This data buffer is 8 bits wide on the write port and 64 bit wide on the read port. The packet length and other control information for each packet are stored in the corresponding entries in the control FIFO. Flow control and discard policy are implemented to avoid FIFO overflow.

The CtrlFIFO write process module 616 controls the address and write enable to the CtrlFIFO 618. It stores the appropriate header fields into CtrlFIFO and processes each header to identify the packet type. This module decodes the Ethernet MAC address to determine the fast-path or host-compatible data packets. It also identifies multicast and broadcast packets. It checks the IP/TCP header and validates MPA CRCs. Once a header is loaded into the control FIFO, it updates the appropriate valid flags to the CtrlFIFO. This module controls a 8 bit date interface to the control FIFO.

The CtrlFIFO 618 is 4 Kbytes deep. Each entry is 64 bytes and contains header information for each corresponding packet stored in the RcvFIFO. This data buffer is 8 bits wide on the write port and 64 bit wide on the read port. Flow control and discard policy are implemented to avoid FIFO overflow.

The Checksum Process module 619 is used to accumulate both IP and TCP checksums. It compares the checksum results to detect any IP or TCP errors. If errors are found, the packet is aborted and all FIFO control pointers are adjusted to the next packet.

The RcvPause process module 620 is used to send flow control packets to avoid FIFO overflows and achieve lossless traffic performance. It follows the 802.3 flow control standards with software controls to enable or disable this function.

The RcvFIFO read process module 622 reads 64 bit data words from RcvFIFO 614, and sends the data stream to PCI or PLB interface 610. This module processes data packets stored in the RcvFIFO 614 in a circular ring to keep the received data packet in order. If the packet is aborted due to network errors, it flushes the packet and updates all control pointers to next packet. After a packet is received and stored in host or local memory, it frees up the data buffer by sends the completion indication to RcvFIFO write process module.

The CtrlFIFO read process module 624 reads 64 bit control words from the CtrlFIFO 618, and examines the control information for each packet to determine its appropriate data path and its packet type. This module processes header information stored in the CtrlFIFO and it reads one entry at a time to keep the received packet in order. If the packet is aborted due to network errors, it updates the control fields of the packet and adjusts pointers to next header entry. After a packet is received and stored in host or local memory, it goes to the next header entry in the control FIFO and repeats the process.

The RXP Main process module 626 takes the control and data information from both RcvFIFO read proc 622 and CtrlFIFO read proc 624, and starts the header and payload transfers to PLB and/or PCI interface 610. It also monitors the readiness of RXDQ and HRXDQ entries for each packet transfer, and updates the completion to RXD and HRXD based on the mode of operation. This module initiates the DMA requests to PLB or PCI for single or multiple data transfers for each received packet. It performs all tables and record lookups to determine the type of operation required for each packet, and operations include hash table search, placement record read, UTRXD lookup, stag information retrieval, PCI address lookup and calculation.

The RXDQ process module 628 is responsible for requesting RXD entry for each incoming packet in fast-path, multicast and broadcast modes. At the end of the packet reception, it updates the flag and status fields in the RXD entry.

The HRXDQ process module 630 is responsible for requesting HRXD entry for each incoming packet in host compatible and broadcast modes. At the end of the packet reception, it updates the flag and status fields in the HRXD entry.

There are two RDMA data placement modes: local mode, and direct mode. In local mode, network packets are placed entirely in the buffer provided by an RXD. In direct mode, protocol headers are placed in the buffer provided by an RXD, but the payload is placed in host memory through a per-connection table as described blow.

In direct mode, there are two classes of data placement: untagged, and tagged. Untagged placement is used for RDMA Send, Send and Invalidate, Send with Solicited Event and Send and Invalidate with Solicited Event messages. Tagged placement is used to place RDMA Read Request, and RDMA Write messages.

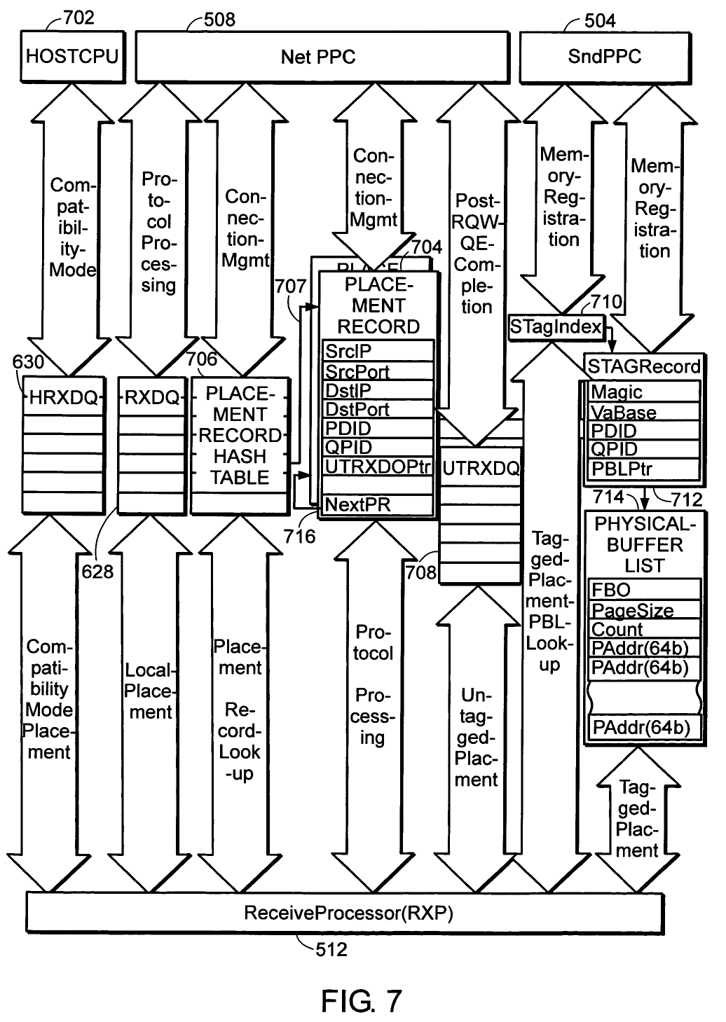

The different modes define which tables are consulted by the RXP when placing incoming data. FIG. 7 illustrates the organization of the tables that control the operation of the RXP 512.

The block arrows illustrate the functionality supported by the data structures to which they point. The Host CPU 702, for example uses the HRXDQ 630 to receive compatibility mode data from the interface. The fine arrows in the figure indicate memory pointers. The data structures in the figure are contained in either SDRAM or block RAM depending on their size and the type and number of hardware elements that require access to the tables.

At the top of the diagram are the Host CPU 702, NetPPC 508, and HostPPC 504. The Host CPU is responsible for scrubbing the HRXDQ 630 that contains descriptors pointing to host memory locations where receive data has been placed for the compatibility interface.

The NetPPC 508 is responsible for protocol processing, connection management and Receive DTO WQE processing. Protocol processing involves scrubbing the RXDQ 628 that contains descriptors pointing to local memory where packet headers and local mode payload have been placed.

Connection Management involves creating Placement Records 704 and adding them to the Placement Record Hash Table 706 that allows the RXP 512 to efficiently locate per-session connection data and per-session descriptor queues. Receive DTO WQE processing involves creating UTRXDQ descriptors 708 (Untagged Receive Descriptor Queue) for untagged data placement, and completing RQ WQE when the last DDP message is processed from the RXDQ.

The HostPPC 504 is responsible for the bulk of Verbs processing to include Memory Registration. Memory Registration involves the creation of STag 710, STag Records 712 and Physical Buffer Lists (PBLs) 714. The STag is returned to the host client when the memory registration verbs are completed and are submitted to the adapter in subsequent Send and Receive DTO requests.

The hardware client of these data structures is the RXP 512. The principle purpose of these data structures, in fact, is to guide the RXP in the processing of incoming network data. Packets arriving with the Compatibility Mode MAC address are placed in host memory using descriptors obtained from the HRXDQ. These descriptors are marked as “used” by setting bits in a Flags field in the descriptor.

Any packet that arrives at the RDMA MAC address will consume some memory in the adapter. The RXDQ 628 contains descriptors that point to local memory. One RXD from the RXDQ will be consumed for every packet that arrives at the RDMA MAC interface. The protocol header, the payload, or both are placed in local memory.

The RXP 512 performs protocol processing to the extent necessary to perform data placement. This protocol processing requires keeping per-connection protocol state, and data placement tables. The Placement Record Hash Table 706, Placement Record 704 and UTRXDQ 708 keep this state. The Placement Record Hash Table provides a fast method for the RXP 512 to locate the Placement Record for a given connection. The Placement Record itself keeps the connection information necessary to correctly interpret incoming packets.

Untagged Data Placement is the process of placing Untagged DDP Message payload in host memory. These memory locations are specified per-connection by the application and kept in the UTRXDQ. An Untagged Receive Descriptor contains a scatter gather list of host memory buffers that are available to place an incoming Untagged DDP message.

Finally, the RXP is responsible for Tagged Mode data placement. In this mode, an STag is present in the protocol header. This STag 710 points to an STag Record 712 and PBL 714 that are used to place the payload for these messages in host memory. The RXP 512 ensures that the STag is valid in part by comparing fields in the STag Record 712 to fields in the Placement Record 704.

The table below provides a detailed description of each of the tables in the diagram.

| Acronym | Name | Description |
|---|---|---|
| HRXDQ | Host | Contains descriptors used by the RXP to |
| | Receive | place data in compatibility mode. |
| | Descriptor | |
| | Queue | |
| RXDQ | Receive | Contains descriptors used by the |
| | Descriptor | RXP to place data in local mode |
| | Queue | and to place the network header portion of |
| | | Tagged and Untagged DDP messages. |
| HT | Hash | A 4096 element array of pointers to Placement |
| | Table | Records. This table is indexed by a hash of the 4- |
| | | tuple key. |
| PR | Placement | A table containing the 4-tuple key and pointers to |
| | Record | placement tables used for untagged and tagged |
| | | mode data placement. |
| UTRXDQ | Untagged | Contains descriptors used for Untagged mode data |
| | Receive | placement. There are as many elements in this |
| | Descriptor | queue as there are entries in the RQ for this |
| | Queue | endpoint/queue-pair. |
| STag | Steering | A pointer to a 16Byte aligned STag Record. The |
| | Tag | bottom 8 bits of the STag are ignored. |
| STag | Steering | A record Steering Tag specific information about |
| Record | Tag | the memory region registered by the client. |
| | Record | |
| PBL | Physical | A page map of a virtually contiguous area of host |
| | Buffer | memory. A PBL may be shared among many |
| | List | Steering Tags. |

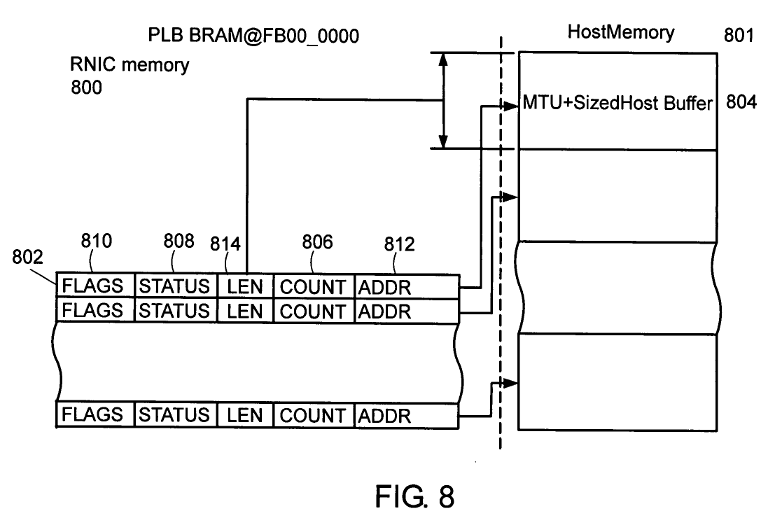

The Host Receive Descriptor Queue 630 is a circular queue of host receive descriptors (HRXD). The base address of the queue is 0xFB00_{—}0000 and the length is 0x1000 bytes. FIG. 8 illustrates the organization of this queue.

A Host 702 populates the queue with HRXD 802 that specify host memory buffers 804 to receive network data. Each buffer specified by an HRXD must be large enough to hold the largest packet. That is, each buffer must be at least as large as the maximum transfer unit size (MTU).

When the RXP 512 has finished placing the network frame in a buffer, it updates the appropriate fields in the HRXD 802 to indicate byte counts 806 and status information 808, updates the FLAGS field 810 of the HRXD to indicate the completion status, and interrupts the Host to indicate that data is available.

More specifically, under preferred embodiments, the format of an HRXD 802 is as follows:

| Field | Length | Description | |
|---|---|---|---|
| FLAGS | 2 | An 8-bit flag word as follows: | |
| | | RXD_READY | This bit is set by the Host to indicate to the |
| | | | RXP that this descriptor is ready to be used. |
| | | | This bit is reset by the RXP before setting the |
| | | | RXD_DONE bit. |
| | | RXD_DONE | This bit is set by the RXP to indicate that the |
| | | | HRXD has been consumed and is ready for |
| | | | processing by the Host. This bit should be set |
| | | | to zero by the Host before setting the |
| | | | RXD_READY bit. |

| | | |
|---|---|---|
| STATUS | 2 | The completion status for the packet. This field is set by the |

| | |
|---|---|
| RXP as follows: | |
| RXD_OK | The packet was placed successfully. |
| RXD_BUF_OVFL | A packet was received that contained |
| | a header and/or payload that was |
| | larger than the specified buffer length. |

| | | |
|---|---|---|
| COUNT | 2 | The number of bytes placed in the buffer by the RXP |
| LEN | 2 | The 16-bit length of the buffer. This field is set by the Host. |
| ADDR | 8 | The 64 bit PCI address of the buffer in host memory. |

Coordination between the Host 702 and the RXP 512 is achieved with the RXD_READY and RXD_DONE bits in the Flags field 810. The Host and the RXP each keep a head index into the HRXDQ. To initialize the system, the Host sets the ADDR 812 and LEN fields 814 to point to buffers 804 in host memory 801 as shown in FIG. 8. The Host sets the RXD_READY bit in each HRXD to one, and all other fields (except ADDR, and LEN) in the HRXD to zero. The Host starts the RXP by submitting a request to a HostPPC verbs queue that results in the HostPPC 504 writing RXP_COMPAT_START to the RXP command register.

The Host keeps a “head” index into the HRXDQ 630. When the FLAGS field 810 of the HRXD at the head index is RXD_DONE, the Host 702 processes the network data as appropriate, and when finished marks the descriptor as available by setting the RXD_READY bit. The Host increments the head index (wrapping as needed) and starts the process again.

Similarly, the RXP 512 keeps a head index into the HRXDQ 630. If the FLAGS field 810 of the HRXD at the head index is not RXD_READY, the RXP waits, accumulating data in the receive FIFO 614. Data arriving after the FIFO has filled will be dropped.

When the RXD_READY bit is set, the RXP 512 places the next arriving frame into the address at ADDR 812 (up to the length specified by LEN 814). When finished, the RXP sets the RXD_DONE bit and increments its head index (wrapping as needed). The RXP interrupts the host if
The queue just went non-empty
At x packets/second, interrupt when the queue is y full or after z milliseconds.

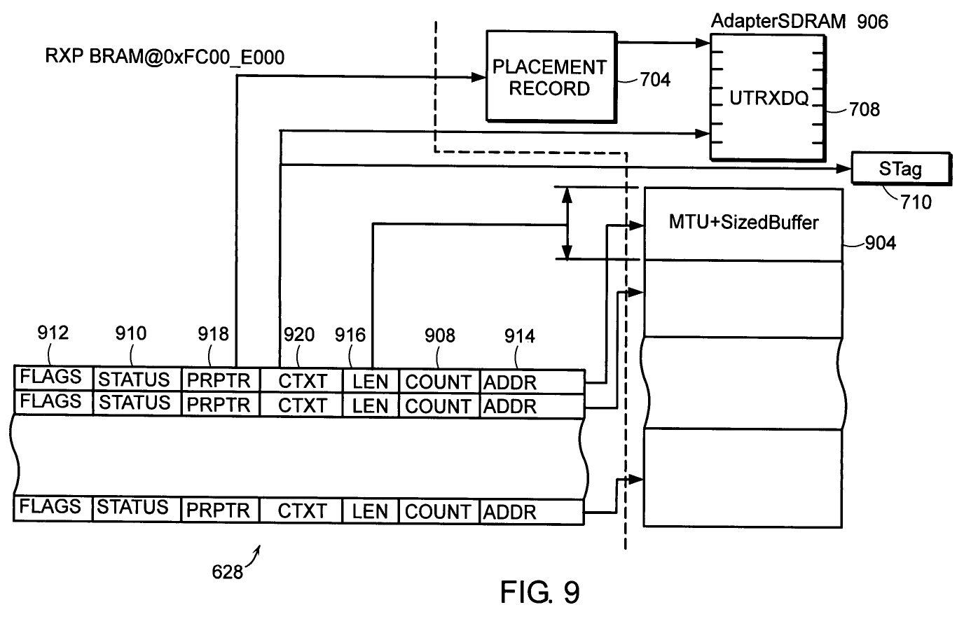

The Receive Descriptor Queue 628 is a circular queue of receive descriptors (RXD). The address of the queue is 0xFC00_E000 and the queue is 0x800 bytes deep. FIG. 9 illustrates the organization of these queues.

The NetPPC 508 populates the receive descriptor queue 628 with RXD 902 that specify buffers 904 in local adapter memory 906 to receive network data. Each buffer 904 specified by an RXD 902 must be large enough to hold the largest packet. That is, each buffer must be at least as large as the MTU.

When the RXP 512 has finished placing the network frame, it updates the appropriate fields in the RXD to indicate byte counts 908 and status information 910 and then updates the Flags field 912 of the RXD to indicate the completion status.

More specifically, under preferred embodiments, the format of an RXD—Receive Descriptor, is as follows:

| Field | Length | Description | |
|---|---|---|---|
| FLAGS | 2 | An 8-bit flag word as follows: | |
| | | RXD_READY | This bit is set by the NetPPC to |
| | | | indicate to the RXP that this |
| | | | descriptor is ready to be used. This bit |
| | | | is reset by the RXP before setting the |
| | | | RXD_DONE bit. |
| | | RXD_DONE | This bit is set by the RXP to indicate |
| | | | that the RXD has been consumed and |
| | | | is ready for processing by the |
| | | | NetPPC. This bit should be set to zero |
| | | | by the NetPPC before setting the |
| | | | RXD_READY bit. |
| | | RXD_HEADER | If set, this buffer was used to place the |
| | | | network header of a packet. If this bit |
| | | | is set, one of either TCP, TAGGED, |
| | | | or UNTAGGED is set as well. |
| | | RXD_TCP | If set, this RXD contains a header for |
| | | | a TCP message. The CTXT field |
| | | | points to a UTRXD. |
| | | RXD_TAGGED | If set, this RXD contains a header for |
| | | | a Tagged DDP message and the |
| | | | CTXT field below contains an STag |
| | | | pointer. |
| | | RXD_UNTAGGED | If set, this RXD contains a header for |
| | | | an Untagged DDP message and the |
| | | | CTXT field below points to an |
| | | | UTRXD. |
| | | RXD_LAST | If set, this is the packet completes a |
| | | | DDP message. |
| STATUS | 2 | The completion status for the packet. This field is set by the | |
| | | RXP as follows: | |
| | | RXD_OK | The packet was placed successfully. |
| | | RXD_BUF_OVFL | A packet was received that contained a |
| | | | header and/or payload that was larger |
| | | | than the specified buffer length. |
| | | RXD_UT_OVFL | A DDP or TCP message was received, |
| | | | but there was no UTRXD available to |
| | | | place the data. |
| | | BAD_QP_ID | The QP ID for an STag didn't match |
| | | | the QP ID in the Placement Record |
| | | BAD_PD_ID | The PP_ID for an STag didn't match |
| | | | the PD_ID in the Placement Record. |

| | | |
|---|---|---|
| ADDR | 4 | The local address of the buffer containing the data |
| COUNT | 2 | The number of bytes placed in the buffer by the RXP |
| LEN | 2 | The length of the buffer (set by the NetPPC) |
| PRPTR | 4 | Pointer to the placement record associated with the protocol |
| | | header. Valid if the HEADER bit in FLAGS is set. |
| CTXT | 4 | If the FLAGS field has the TAGGED bit set, this field contains |
| | | the STag that completed. If the UNTAGGED bit is set, this |
| | | field contains a pointer to the UTRXD that was used to place |
| | | the data. This field is set by the RXP. |
| RESERVED | 12 | |
| Total | 32 | |

Coordination between the NetPPC 508 and the RXP 512 is achieved with the RXD_READY and RXD_DONE bits in the Flags field 912. The NetPPC and the RXP keep a head index into the RXDQ. To initialize the system, the NetPPC sets the Addr 914 and Len fields 916 to point to buffers in PLB SDRAM 906 as shown in FIG. 9. The NetPPC sets the RXD_READY bit in each RXD 902 to one, and all other fields (except Addr, and Len) in the RXD to zero. The NetPPC starts the RXP by writing RXP_START to the RXP command register.

The NetPPC 508 keeps a “head” index into the RXDQ 628. When the Flags field 912 of the RXD at the head index is RXD_DONE, the NetPPC processes the network data as appropriate, and when finished marks the descriptor as available by setting the RXD_READY bit. The NetPPC increments the head index (wrapping as needed) and starts the process again.

Similarly, the RXP 512 keeps a head index into the RXDQ 628. If the Flags field 912 of the RXD 902 at the head index is not RXD_READY, the RXP drops all arriving packets until the bit is set. When the RXD_READY bit is set, the RXP places the next arriving frame into the address at Addr 914 (up to the length specified by Len 916) as described in a later section. When finished, the RXP sets the RXD_DONE bit, increments its head index (wrapping as needed) and continues with the next packet.

### Per-Connection Data Placement Tables

Untagged and tagged data placement use connection specific application buffers to contain network payload. The adapter copies network payload directly into application buffers in host memory. These buffers are described in tables attached to a Placement Record 704 located in a Hash Table (HT) 706 as shown in FIGS. 7 and 9, for example.

The HT 706 is an array of pointers 707 to lists of placement records. Under certain embodiments, the hash index is computed as follows:

```
uint32 hash(uint32 src_ip,
    uint16 src_port,
    uint32 dst_ip,
    uint16 dst_port)
{
    int h;
    h = ((src_ip XOR src_port) XOR (dst_ip XOR dst_port));
    h = h XOR (h SHIFT_RIGHT 16);
    h = h XOR (h SHIFT_RIGHT 8);
    return h MODULO 4096;
}
```

The algorithm for locating the data placement record follows:

```
const int32 hash_tbl_size = 4096;
placement_record find_placement_record(
    int32 src_ip,
    int16 src_port,
    int32 dest_ip,
    int16 dest_port)
{
    placement_record pr;
    int32 index;
    index = hash (src_ip, src_port, dest_ip, dest_port)
        MODULO hash_tbl_size;
    pr = hash_table[index];
    while (pr != NULL) {
    if (  (src_ip EQUALS pr.src_ip) AND
        (dest_ip EQUALS pr.dest_ip) AND
        (src_port EQUALS pr.src_port) AND
        (dest_port EQUALS pr.dest_port))
        {
        return pr;
        }
    }
    pr = pr.next;
    }
    return pr;
}
```

The contents of a Placement Record 704 are as follows:

| | Size | | |
|---|---|---|---|
| Field | (Bytes) | Description | |
| Src IP | 4 | The source IP address | |
| Dest IP | 4 | Destination IP address | |
| Src Port | 2 | The source port number | |
| Dest Port | 2 | Destination port number | |
| Type | 1 | The PCB type: | |
| | | RDMAP | |
| Flags | 1 | 8bit Status Field: | |
| | | RDMA_MODE | Setting this flag |
| | | | causes the RXP to |
| | | | transition to RDMA |
| | | | placement/MPA |
| | | | framing mode. |
| | | Last_Entry | Setting this flag |
| | | | to indicate that this |
| | | | is the last entry |
| | | | in the placement |
| | | | record list. |

| | | |
|---|---|---|
| UTRXQ Depth | 1 | The number of descriptors |
| Mask | | in the UTRXQ specified as a |
| | | limit mask. The depth must be |
| | | a power of 2. The mask is |
| | | computed as depth −1. |
| RESERVED | 1 | |
| PD ID | 4 | Protection Domain ID |
| QP ID | 4 | QP or EP ID |
| UTRXQ Ptr | 4 | Pointer to the UTRXQ. |
| | | A UTRXQ must be located on a |
| | | 256 B boundary. |
| Next Ptr | 4 | Pointer to the next PR |
| | | that hashes to the same bucket |
| PCB Ptr | 4 | A pointer to the Protocol |
| | | Control Block for this stream |
| MTU | 2 | The MTU on the route from |
| | | this host to the remote peer. |
| RESERVED | 2 | |
| Total Size | 40 | |

The UTRXDQ 708 is an array of UTRXD used for the placement of Untagged DDP messages. This table is only used if the RDMA_MODE bit is set in the Placement Record 704. An untagged data receive descriptor (UTRXD) contains a Scatter Gather List (SGL) that refers to one or more host memory buffers. (Thus, though the host memory is virtually contiguous, it need not be physically contiguous and the SGL supports non-contiguous placement in physical memory.) Network data is placed in these buffers in order from first to last until the payload for the DDP message has been placed.

The NetPPC 508 populates the UTRXDQ 708 when the connection is established and the Placement Record 704 is built. The number of elements in the UTRXDQ varies for each connection based on parameters specified by the host 702 and messages exchanged with the remote RDMAP peer. The UTRXDQ 708 and the UTRXD are allocated by the NetPPC 508. The base address of the UTRXDQ is specified in the placement record.

If there are no UTRXD remaining in the queue 708 when a network packet arrives for the connection, the packet is placed locally in adapter memory.

The table below illustrates a preferred organization for an untagged receive data descriptor (UTRXD).

| | Size | | |
|---|---|---|---|
| Field | (Bytes) | Description | |
| FLAGS | 1 | RXP_DONE | This bit is reset by software |
| | | | and set by hardware. The |
| | | | RXP sets this value when |
| | | | a DDP message with the |
| | | | last bit in the header is |
| | | | placed. The RXP will place |
| | | | all data for this DDP |
| | | | message locally after |
| | | | this bit is set. |

| | | |
|---|---|---|
| RESERVED | 3 | |
| SGL_LEN | 4 | Total length of this SGL |
| MN | 4 | The DDP message number placed |
| | | using this descriptor. This value is |
| | | set by firmware and used by hardware |
| | | to ensure that the incoming message |
| | | is for this entry and isn't an |
| | | out-of-order segment whose MN |
| | | is an alias for this MN in the UTRDQ. |
| SGECNT | 4 | Number of entries in SGE ARRAY |
| CONTEXT | 8 | A NetPPC specified context value. |
| | | This field is not used or modified |
| | | by the RXP. |
| SGEARRAY | ? | An array of Scatter Gather |
| | | Entries (SGE) as defined below. |

The table below illustrates a preferred organization for an entry in the scatter gather list (SGE).

| Field | Size | Description |
|---|---|---|
| STAG | 4 | A steering tag that was returned |
| | | by a call to one of the memory |
| | | registration API or WR. The top |
| | | 24 bits of the STag is a pointer |
| | | to a STag record as described below. |
| LEN | 2 | The length of a buffer in the |
| | | memory region or window |
| | | specified by STag. |
| RESERVED | 2 | |
| TO | 8 | The offset of buffer in the memory |
| | | region or window specified |
| | | by STag. |

Connection setup and tear down is handled by software. After the connection is established, the firmware creates a Placement Record 704 and adds the Placement Record to the Hash Table 706. Immediately following connection setup, the protocol sends an MPA Start Key and expects an MPA Start Key from the remote peer. The MPA Start Key has the following format:

| Bytes | Bits | Contents | |
|---|---|---|---|
| 0-14 | | “MPA ident frame” | |
| | | Name | Description |
| 15 | 0 | M | Declares a receiver's requirement for Markers. |
| | | | When ‘1’, markers must be added when |
| | | | transmitting to this peer. |
| | 1 | C | Declares an endpoint‘s preferred CRC usage. |
| | | | When this field is ‘0’ from both |
| | | | endpoints, CRCs must not be checked and |
| | | | should not be generated. When this bit is ‘1’ |
| | | | from either endpoint, CRCs must be generated and |
| | | | checked by both endpoints. |
| | 2-3 | Res | Reserved for future use, must be sent as zeroes |
| | | | and not checked by receiver. |
| | 4-7 | Rev | MPA revision number. Set to zero for this version of |
| | | | MPA. |

Following MPA (Marker PDU Architecture) protocol initialization, the RDMAP protocol expects a single MPA PDU containing connection private data. If no private data is specified at connection initialization, a zero length MPA PDU is sent. The RDMAP protocol passes this data to the DAT client as connection data.

Given the connection data, the client configures the queue pairs QP and binds the QP to a TCP endpoint. At this point, the firmware transitions the Placement Record to RDMA Mode by setting the RDMA_ENABLE bit in the Placement Record.

When the firmware inserts a Placement Record 704 into the Hash Table 706 it must first set the NextPtr field 716 of the new Placement Record to the value in the Hash Table bucket, and then set the Hash Table bucket pointer to point to the new Placement Record. A race occurs between the time the NextPtr field is set in the new Placement Record and before the Hash Table bucket head has been updated. If the arriving packet is for the new connection, the artifact of the race is that the RXP will not find the newly created Placement Record and place the data locally. Since this is the intended behavior for a new Placement Record, this race is benign. If the arriving packet is for another connection, the RXP will find the Placement Record for that connection because the Hash Table head has not yet been updated and the list following the new Placement Record is intact. This race is also benign.

The removal of a placement record 704 should be initiated after the connection has been completely shut down. This is done by locating the previous Placement Record or Hash Table bucket and setting it to point to the Placement Record NextPtr field.

The Placement Record should not be reused or modified until at least one additional frame has arrived at the interface to ensure that the Placement Record is not currently being used by the RXP.

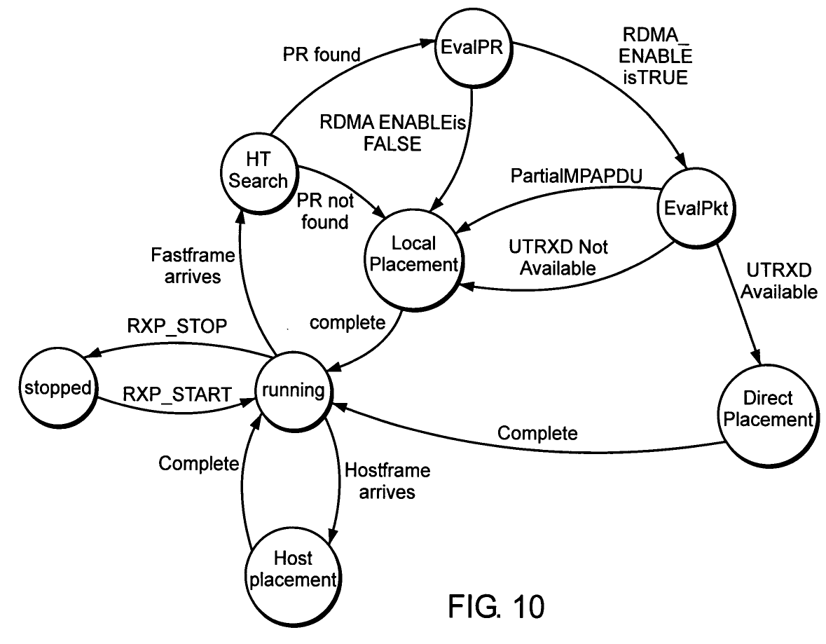

FIG. 10 is a state diagram, depicting the states of the RXP on the reception of a RDMA packet. In the diagram the abbreviation PR stands for placement record, and “Eval” stands for evaluate. The state “direct placement” refers to the state of directly placing data in host memory, discussed above.

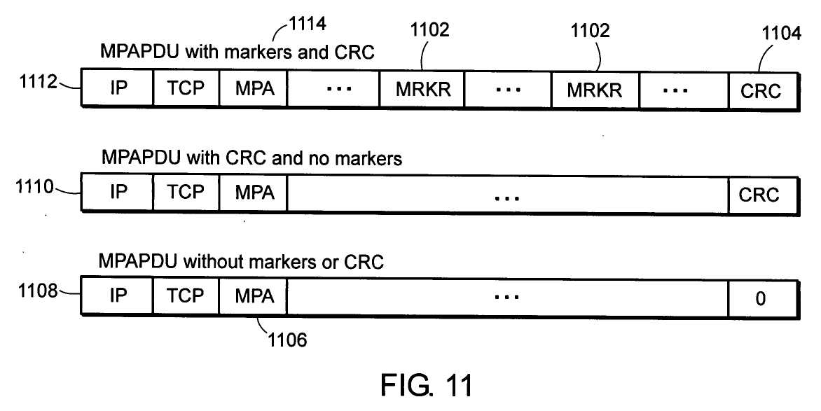

The Marker PDU Architecture (MPA) provides a mechanism to place message oriented upper layer protocol (ULP) PDU on top of TCP. FIG. 11 illustrates the general format of an MPA PDU. Because markers 1102 and CRC 1104 are optional, there are three variants shown.

MPA 1106 enables the reliable location of record boundaries in a TCP stream if markers, the CRC, or both are present. If neither the CRC nor markers are present, MPA is ineffective at recovering lost record boundaries resulting from dropped or out of order data. For this reason, the variant 1108 with neither CRC nor markers isn't considered a practical configuration.

For receive, the RXP 512 supports only the second variant 1110, i.e. CRC without markers. When sending the MPA Start Key, the RXP will specify M:0 and CRC:1 which will force the sender to honor this variant.

The RXP 512 will recognize complete MPA PDU, and is able to resynchronize lost record boundaries in the presence of dropped and out of order arrival of data. The RXP does not support IP fragments. If the FRAG bit is set in the IP header 1112, the RXP will deliver the data locally.

The algorithm supported by the RXP for recognizing a complete MPA PDU is to first assume that the packet is a complete MPA PDU. If this is the case, then do the following:
1. The value in the MPA Header 1114+offset of the MPA Header from the start of the packet equals the total length specified in the IP Header 1112, and
2. The CRC 11104 located at the end of the packet matches the MPA CRC computed on the current MPA PDU.

Under preferred embodiments, if either of these assertions is false, the packet is placed locally.

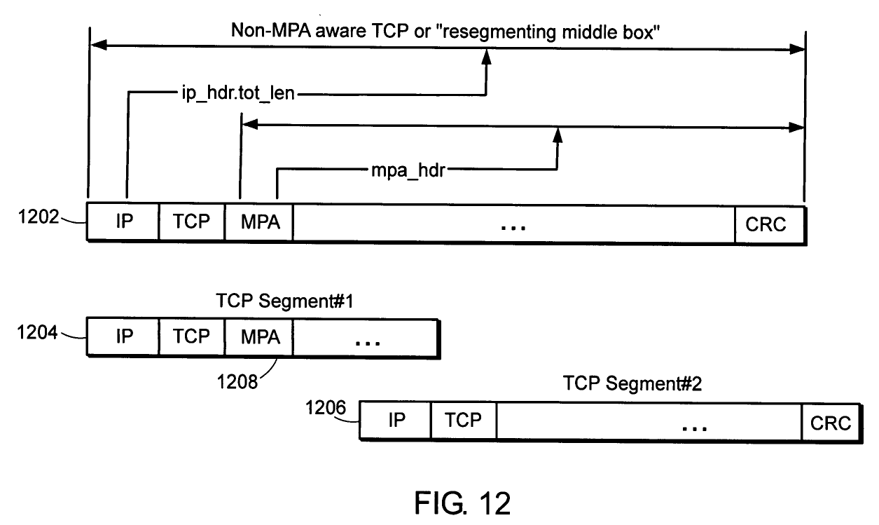

As depicted in FIG. 12 an MPA PDU 1202 is broken into two TCP segments 1204, 1206. Regardless of how this could possibly happen, the first and second segments are recognized as impartial MPA PDU fragments and placed locally. The first segment 1204 contains an MPA header 1208; however, the length in the header reaches beyond the end of the segment and therefore per rule 1 above is placed locally. The second segment 1208 doesn't contain an MPA header, but does contain the trailing segment. In this case, even if by chance the bytes following TCP header were to correctly specify the length of the packet, the trailing CRC would not match the payload and per rule 2 above would be placed locally.

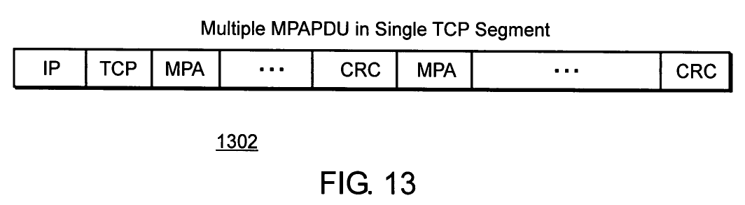

FIG. 13 shows a single TCP segment 1302 that contains multiple MPA PDU. Although this is legal, the RXP 512 will place this locally. Under preferred embodiments of the invention, the transmit policy is to use one PDU per TCP segment.

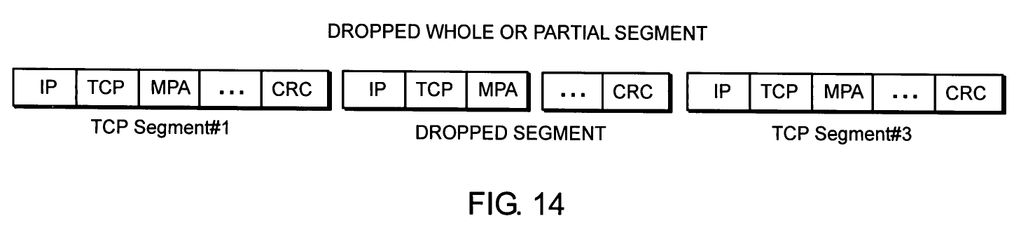

FIG. 14 shows a sequence of three valid MPA PDU in three TCP segments. The middle segment is lost. In this case, the first and third segments will be recognized as valid and directly placed. The missing segment will be retransmitted by the remote peer because TCP will only acknowledge the first segment.

It should be noted, in this case, that placing the third segment out of order is of questionable value because it will be retransmitted by the remote peer and directly placed a second time. In order to take advantage of the receipt and placement of the third segment, we will need to support selective acknowledgement.

### Untagged RDMAP Placement

The Queue Number, Message Number, and Message Offset are used to determine whether the data is placed locally or directly into host memory.

If the Queue Number in the DDP header is 1 or 2, the packet is placed locally. These queue numbers are used to send RDMA Read Requests and Terminate Messages respectively. Since these messages are processed by the RDMAP protocol in firmware, they are placed in local memory.

If the Queue Number in the DDP header is 0, the packet is a RDMA Send, RDMA Send and Invalidate, RDMA Send with Solicited Event, or RDMA Send and Invalidate with Solicited Event. In all of these cases, the payload portion of these messages is placed directly into host memory.

A single UTRXD is used to place the payload for a single Untagged DDP message. A single Untagged DDP message may span many network packets. The first packet in the message contains a Message Offset of zero. The last packet in the message has the Last Bit set to ‘1’. All frames that comprise the message are placed using a single UTRXD. The payload is placed in the SGL without gaps.

The hardware uses the Message Number in the DDP header to select which of the UTRXD in the UTRXDQ is used for this message. The Message Offset in conjunction with the SGL in the selected UTRXD is used to place the data in host memory. The Message Number MODULO the UTRXDQ Depth is the index in the UTRXDQ for the UTRXD. The SGL consists of an array of SGE. An SGE in turn contains an STag, Target Offset (TO), and Length.

The protocol headers in each of the packets that comprise the message are placed in local RNIC memory. Each packet consumes an RXD from the RXDQ. The NetPPC 508 will therefore “see” every packet of an Untagged DDP message.

The RXP 512 updates the RXD 902 as follows:
All header bytes up to and including the DDP header are placed in the buffer 904 pointed to by the ADDR field 914.
The COUNT field 916 is set to the length of the protocol header placed at ADDR
The FLAGS field 912 is set as follows:
   The HEADER bit is set
   The UNTAGGED bit is set
   The LAST bit is set if this is the last network packet in the message (as indicated by the Last bit in the DDP header).
The PRPTR field 918 is set to point to the Placement Record 704.
The CTXT field 920 is filled with a pointer to the associated UTRXD 708.

The UTRXD 708 is used for data placement as follows:
The Message Number in the UTRXD is compared to the Message Number in the DDP header. If they do not match, the DDP message received is for a subsequent message for which there is no UTRXD entry. In this case, the data is placed locally.

The Message Offset is used to locate the SGE

```
base_offset = 0;
bytes_remaining = DDP.Message_Length
for (i=0; i < sge_count; i++) {
    if (DDP.Message_Offset > base_offset + UTRXD.SGE[i].Length)
    {
    base_offset = base_offset + UTRXD.SGE[i].Length;
    continue;
    }
    if (UTRXD.SGE[i].STag.QP_ID != 0 &&
    UTRXD.SGE[i].STag.QP_ID != PlacementREcord.QD_ID) {
    UTRXD.Flags |= BAD_QP_ID;
    break;
    }
    if (UTRXD.SGE[i].STag.PD_ID !=
    PlacementREcord.PD_ID) {
    UTRXD.Flags |= BAD_PD_ID;
    break;
    }
    sge_offset = DDP.Message_Offset − base_offset;
    sge_remaining = UTRXD.SGE[i].Length − sge_offset;
    if (bytes_remaining > sge_remaining)
    copy_bytes = sge_remaining;
    else
    copy_bytes = bytes_remaining;
    TO = UTRXD.SGE[i].TO + sge_offset;
    CopyToPCI(UTRXD.SGE[i].STag, TO, copy_bytes);
    bytes_remaining = bytes_remaining − copy_bytes;
    if (bytes_remaining != 0)
    continue;
    break;
}
if (UTRXD.Flags == 0 && bytes_remaining != 0) {
    RXD.Flags != RXD_ERROR;
    UTRXD.Flags |= OVERFLOW;
}
```

The contents of the UTRXD 708 are updated as follows:
Bits in the FLAGS field are set
   If the Last bit was set in the RXD, the COMPLETE bit is set
   If an error was encountered the ERROR bit is set
The COUNT field is updated with the number of additional bytes written to the SGL

To complete processing, the RXP 512 sets the RXD_DONE bit and resets the RXD_DONE bit in the RXD 902.

If the SGL in the UTRXD is exhausted before all data in the DDP message is placed, an error descriptor (ERD) is posted to the RXDQ 628 to indicate this error.

### Host Memory Representation

An STag is a 32-bit value that consists of a 24-bit STag Index 710 and an 8-bit STag Key. The STag Index is specified by the adapter and logically points to an STag Record. The STag Key is specified by the host and is ignored by the hardware.

Logically, an STag is a network-wide memory pointer. STags are used in two ways: by remote peers in a Tagged DDP message to write data to a particular memory location in the local host, and by the host to identify a virtually contiguous region of memory into which Untagged DDP data may be placed. STags are provided to the adapter in a scatter gather list (SGL).

In order to conserve memory in the adapter, an STag Index is not used directly to point to an STag Record. An Stag Index is “twizzled” as follows to arrive at an STag Record Pointer as follows:
STag Record Ptr=(STag Index>>3)|0xE0000000;

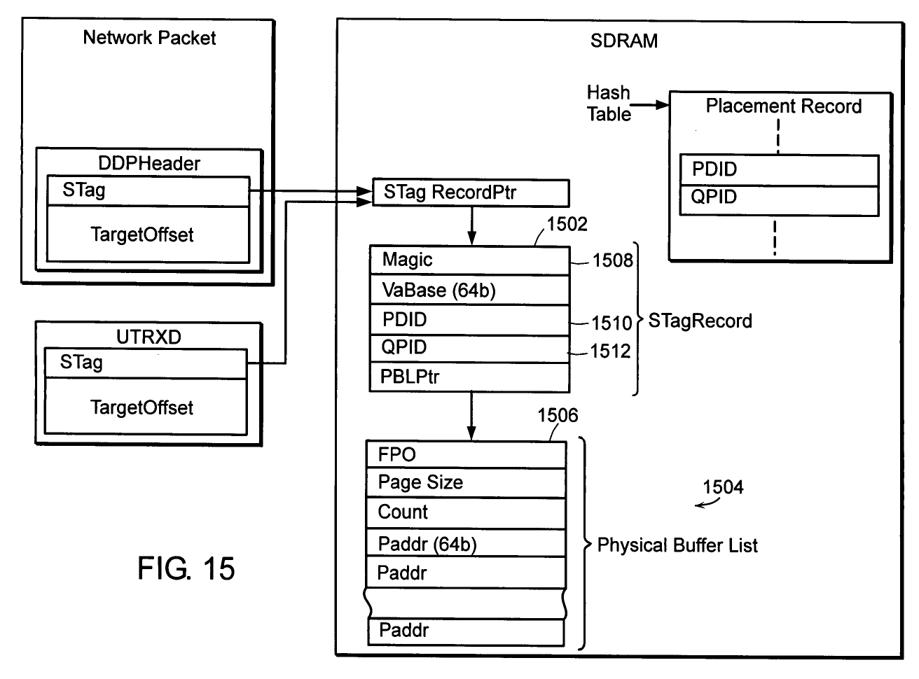

FIG. 15 illustrates the organization of the various data structures that support STags. The STag Record 1502 contains local address and endpoint information for the STag. This information is used during data placement to identify host memory and to ensure that the STag is only used on the appropriate endpoint.

| Field | Size | Description | |
|---|---|---|---|
| MAGIC | 2 | A number (global to all STag) specified when the STag was registered. | |
| | | This value is checked by the hardware to validate a potentially | |
| | | corrupted or forged STag specified in a DDP message. | |
| STATE | 1 | ‘1’ | VALID: Cleared by RXP when receiving a Send |
| | | | and Invalidate RDMA message. This bit is set by |
| | | | the software to allow RXP for RDMA. If this bit is |
| | | | not set, RXP will abort all received packets |
| | | | associated with this STAG record. |
| | | ‘2’ | SHARED: Used by firmware |
| | | ‘4’ | WINDOW: Used by firmware |
| ACCESS | 1 | ‘1’ | LOCAL_READ: Checked by firmware when |
| | | | posting RQ WR. Checked by hardware for RDMA |
| | | | Read Reply. |
| | | ‘2’ | LOCAL_WRITE: Checked by firmware when |
| | | | posting an RQ WR |
| | | ‘4’ | REMOTE_READ: Checked by the firmware |
| | | | before responding to a RDMA Read Request. |
| | | ‘8’ | REMOTE_WRITE: Checked by the hardware |
| | | | before placing a received RDMA Write request. |

| | | |
|---|---|---|
| PBLPTR | 4 | Pointer to the Physical Buffer List for the virtually contiguous memory |
| | | region specified by the STag. |
| PD ID | 4 | The Protection Domain ID. This value must match the value specified |
| | | in the Placement Record for this connection. |
| QP ID | 4 | The Queue Pair ID. This value must match the QP ID |
| | | contained in the Placement Record. |
| VABASE | 8 | The virtual address of the base of the virtually contiguous |
| | | memory region. This value may be zero. |
| | 32 | |

The Physical Buffer List 1504 defines the set of pages that are mapped to the virtually contiguous host memory region. These pages may not themselves be either contiguous or even in address order.

| Field | Size | Description |
|---|---|---|
| FBO | 2 | The offset into the first page in the list |
| | | where the virtual memory region begins. |
| | | The VABASE specified in the STag Record |
| | | MODULO the PGSIZE below must equal |
| | | this value. |
| PGBYTES | 2 | The size in bytes of each page in the list. |
| | | All pages must be the same size. The page |
| | | size must be modulo of 2. |
| REFCNT | 4 | The number of STags that point to this PBL. This is |
| | | incremented and decremented by software when |
| | | creating and destroying STags as part of memory |
| | | registration and is used to know when it is |
| | | safe to destroy the PBL. |
| PGCOUNT | 3 | The number of pages in the array that follows |
| RESERVED | 1 | |
| PGARRY | 8+ | An array COUNT elements long of |
| | | 64-bit PCI addresses. |

A PBL 1504 can be quite large for large virtual mappings. The PBL that represents a 16 MB memory region, for example, would contain 4096 8-byte PCI addresses. The PBL would require 12+8*4096=32,780 bytes of memory.

An STag logically identifies a virtually contiguous region of memory in the host. The mapping between the STag and a PCI address is implemented with the Physical Buffer List 1504 pointed to by the PBL pointer 1506 in the STag Record 1502.

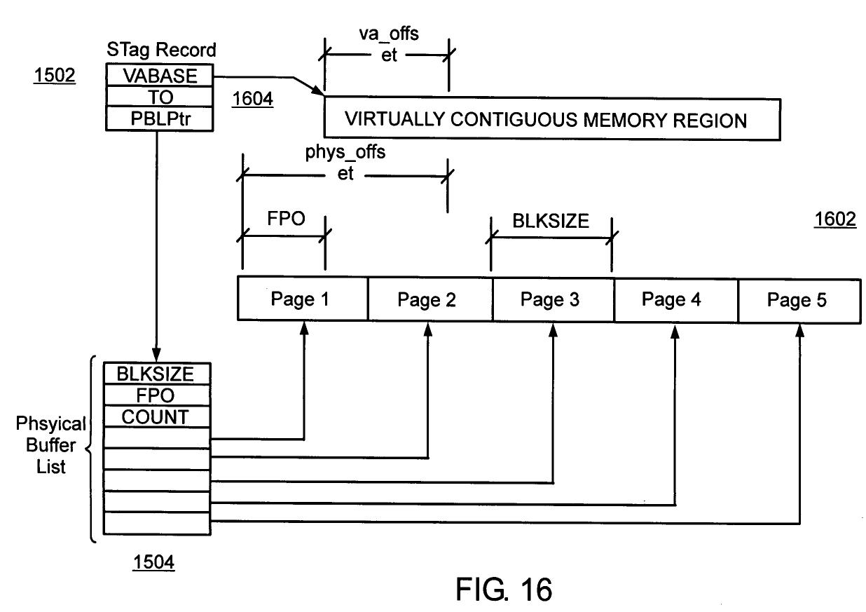

FIG. 16 illustrates how the PBL 1504 maps the virtual address space. The physical pages in the figure are shown as contiguous to make the figure easy to parse; however, in practice they need not be physically contiguous.

The mapping of an STag and target offset (TO) to a PCI address is accomplished as follows:

```
map_to_pci(STag, TO, Len)
{
    /* get pointer to the STag Record from the STag */
    stag_record_ptr = ((STag & 0xFFFFFF00) >> 3) | 0xE0000000;
    /* Compute the offset into the virtual memory region */
    va_offset = TO − stag_record->vabase;
    /* Note that the first page offset is added to
      * the virtual offset. This is because the memory
      * region may not start at the beginning of a page */
    pbl_offset = va_offset + stag_record_ptr->pblptr->fbo;
    /* Compute the page number in the PBL.
    page_no = pbl_offset / stag_record_ptr->pblptr->pgsize;
    pci_address = stag_record_ptr->pbl[page_no]
    + (pbl_offset % stag_record_ptr->pblptr->pgsize);
}
```

Note that after determining the PCI address, the data transfer must be broken up into separate transfers for each page in the PBL. Larger transfers will consist of partial page transfers for the first and last pages and full page size transfers for intermediate pages.

Tagged mode placement is used for RDMA Read Response and RDMA Write messages. In this case, the protocol header identifies the local adapter memory into which the payload should be placed.

The RXP 512 validates the STag 1502 as follows:
The MAGIC field 1508 in the STag Record must be valid
The PD ID 1510 in STag Record must match the PD ID in the Placement Record
If the queue pair (QP) ID 1512 in the STag Record is not-zero, the QP ID in the STag Record must match the QP ID in the Placement Record
The Valid bit in the STag must be set.
The Access bits in the STag Record must allow remote write.

The RXP 512 places the payload into the memory 1602 described by the PBL 1504 associated with the STag 1502. The payload is placed by converting the TO 1604 (Target Offset) specified in the DDP protocol header to an offset into the PBL as described above and then copying the payload into the appropriate pages 1602.

The RXP 512 places the protocol header for the Tagged DDP message in an RXD 902 as follows:
The FLAGS field 912 is set as follows:
   The HEADER bit is set
   The TAGGED bit is set
   The LAST bit is set
The PRPTR 918 field is set to point to the Placement Record
The COUNT field 908 is set to the length of the protocol header placed at ADDR
The CTXT field 920 is set to point to the STag Record 710

To complete processing, the RXP 512 sets the RXD_DONE bit and resets the RXD_DONE bit in the RXD 902.

Persons skilled in the art may appreciate that several public domain TCP/IP stack implementations (e.g., BSD 4.4) provided operating system networking software that utilized a hashing algorithm to locate protocol state information given a source IP address, destination IP address, source port, destination port and protocol identifier. Those approaches however were not used locate information identifying where to place network payload (directly or indirectly), and were operating system based code.

The invention may be embodied in other specific forms without departing from the spirit or essential characteristics thereof. The present embodiments are therefore to be considered in respects as illustrative and not restrictive, the scope of the invention being indicated by the appended claims rather than by the foregoing description, and all changes which come within the meaning and range of the equivalency of the claims are therefore intended to be embraced therein.

The invention claimed is:

1. A network adapter system for use in a computer system including a host processor and host memory and for use in network communication in accordance with a direct data placement (DDP) protocol, wherein said DDP protocol specifies tagged and untagged data movement into a connection-specific application buffer in a contiguous region of virtual memory space of a corresponding endpoint computer application executing on said host processor, and wherein said tagged data movement includes a tagged message that provides an identifier for said connection-specific application buffer and wherein untagged data movement includes an untagged message that provides no identifier for said connection-specific application buffer, the network adapter system comprising:
adapter memory;
a plurality of placement records in said adapter memory, each placement record specifying per-connection placement data including at least network address information and port identifications of source and destination network entities for a corresponding DDP protocol connection;
placement record identification logic to uniquely identify a placement record from network address information and port identification information contained in a DDP message received by the network adapter system;
untagged message payload placement logic, responsive to a received untagged DDP message, utilizing first information in a uniquely identified, corresponding placement record to directly place the payload of the received untagged DDP message into physical address locations of host memory corresponding to one of said connection-specific application buffers;
tagged message payload placement logic, responsive to a received tagged DDP message, utilizing second information in a uniquely identified, corresponding placement record to validate the received tagged DDP message and if said message is valid directly placing the payload of the tagged DDP message into physical address locations of host memory corresponding to the identifier in the received DDP message.

2. The adapter of claim 1 wherein said placement records are organized as an array of hash buckets with each element of the array containing a placement record and each placement record containing a specification of a next placement record in the same bucket, and wherein said placement record identification logic includes hashing logic to create a hash index pointing to a bucket in the array by hashing a 4-tuple consisting of a source address, a destination address, a source port, and a destination port contained in the received DDP message.

3. The adapter of claim 1 including at least one physical buffer list to specify physical address locations of host memory corresponding to the identifier in a received DDP message and to specify physical address locations of host memory for one of said connection-specific application buffers corresponding to a received untagged DDP message.

4. The adapter of claim 3 wherein said physical buffer list is a list of pages of physical memory that need not be physically contiguous.

5. The adapter of claim 4 wherein said physical buffer list is identified via a corresponding steering tag.

6. The adapter of claim 5 wherein the identifier in a tagged DDP message is a steering tag.

7. The adapter of claim 6 wherein said second information in a placement record includes queue pair identification information corresponding to the steering tag in the tagged DDP message, and protection domain identification information corresponding to the steering tag in the tagged DDP message, and wherein the tagged message payload placement logic further utilizes a sequence number in said DDP message to validate the received tagged DDP message.

8. The adapter of claim 5 further including a queue of descriptors for connection-specific application buffers for untagged DDP messages, wherein said descriptors include steering tags provided by software executing on said host processor when a connection is established.

9. The adapter of claim 8 wherein a placement record includes a pointer to said queue of descriptors for connection-specific application buffers for untagged DDP messages, and wherein said untagged message payload placement logic generates an index into said queue to identify a descriptor to identify host memory locations into which the DDP message payload is to be directly placed.

10. The adapter of claim 9 wherein the queue of descriptors has a specified depth and wherein a tagged DDP message includes a sequence number and wherein the index is sequence number MODULO specified depth of queue of descriptors.

11. The adapter of claim 8 wherein said DDP message includes queue number information and said adapter analyzes said queue number information to determine whether said DDP message is an untagged DDP message.

12. The adapter of claim 8 wherein a single queue of descriptors is used to place the payload of a single untagged DDP message.

13. The adapter of claim 12 wherein a single untagged DDP message spans a plurality of network packets.

14. The adapter of claim 13 wherein the first network packet of a single untagged DDP message contains a message offset having a zero value.

15. The adapter of claim 13 wherein the last network packet of a single untagged DDP message contains a last but flag set to true.

16. The adapter of claim 10 wherein the descriptors include message numbers and wherein tagged DDP messages include message numbers and wherein tagged message payload placement logic compares the message number in a descriptor to the message number in the tagged DDP message to validate the DDP message.

17. The adapter of claim 10 wherein the descriptor includes a message offset and wherein the tagged message payload placement logic uses the message offset to access an entry in the physical buffer list.

18. The adapter of claim 7 wherein software executing on said host processor binds a queue pair with specified TCP endpoints when a connection is established.

19. A network communication method of handling messages in accordance with a direct data placement (DDP) protocol, wherein said DDP protocol specifies tagged and untagged data movement into a connection-specific application buffer in a contiguous region of virtual memory space of a corresponding endpoint computer application executing on a host processor, and wherein said tagged data movement includes a tagged message that provides an identifier for said connection-specific application buffer and wherein untagged data movement includes an untagged message that provides no identifier for said connection-specific application buffer, the network communication method comprising:
providing a plurality of placement records, each placement record specifying per-connection placement data including at least network address information and port identifications of source and destination network entities for a corresponding DDP protocol connection;
in response to receiving a DDP message containing network address information and port identification information, uniquely identifying a placement record;
in response to receiving an untagged DDP message, utilizing first information in a uniquely identified, corresponding placement record to directly place the payload of the received untagged DDP message into physical address locations of host memory corresponding to one of said connection-specific application buffers;
in response to receiving a tagged DDP message tagged message, utilizing second information in a uniquely identified, corresponding placement record to validate the received tagged DDP message and if said message is valid directly placing the payload of the tagged DDP message into physical address locations of host memory corresponding to the identifier in the received DDP message.

20. The method of claim 19 wherein said placement records are organized as an array of hash buckets with each element of the array containing a placement record and each placement record containing a specification of a next placement record in the same bucket, and wherein identifying a placement record includes hashing a 4-tuple consisting of a source address, a destination address, a source port, and a destination port contained in the received DDP message to create a hash index pointing to a bucket in the array.

21. The method of claim 19 including at least one physical buffer list to specify physical address locations of host memory corresponding to the identifier in a received DDP message and to specify physical address locations of host memory for one of said connection-specific application buffers corresponding to a received untagged DDP message.

22. The method of claim 21 wherein said physical buffer list is a list of pages of physical memory that need not be physically contiguous.

23. The method of claim 22 wherein said physical buffer list is identified via a corresponding steering tag.

24. The method of claim 23 wherein the identifier in a tagged DDP message is a steering tag.

25. The method of claim 24 wherein said second information in a placement record includes queue pair identification information corresponding to the steering tag in the tagged DDP message, and protection domain identification information corresponding to the steering tag in the tagged DDP message, and placing the payload of a tagged message further utilizes a sequence number in said DDP message to validate the received tagged DDP message.

26. The method of claim 23 further including a queue of descriptors for connection-specific application buffers for untagged DDP messages, wherein said descriptors include steering tags provided by software executing on said host processor when a connection is established.

27. The method of claim 26 wherein a placement record includes a pointer to said queue of descriptors for connection-specific application buffers for untagged DDP messages, and wherein placing the payload of an untagged message includes generating an index into said queue to identify a descriptor to identify host memory locations into which the DDP message payload is to be directly placed.

28. The method of claim 27 wherein the queue of descriptors has a specified depth and wherein a tagged DDP message includes a sequence number and wherein the index is sequence number MODULO specified depth of queue of descriptors.

29. The method of claim 26 wherein said DDP message includes queue number information and the method further includes analyzing said queue number information to determine whether said DDP message is an untagged DDP message.

30. The method of claim 26 wherein a single queue of descriptors is used to place the payload of a single untagged DDP message.

31. The method of claim 32 wherein a single untagged DDP message spans a plurality of network packets.

32. The method of claim 31 wherein the first network packet of a single untagged DDP message contains a message offset having a zero value.

33. The method of claim 31 wherein the last network packet of a single untagged DDP message contains a last but flag set to true.

34. The method of claim 28 wherein the descriptors include message numbers and wherein tagged DDP messages include message numbers and wherein placing the payload of a tagged message includes comparing the message number in a descriptor to the message number in the tagged DDP message to validate the DDP message.

35. The method of claim 28 wherein the descriptor includes a message offset and wherein placing the payload of a tagged message includes using the message offset to access an entry in the physical buffer list.

36. The method of claim 25 wherein software executing on said host processor binds a queue pair with specified TCP endpoints when a connection is established.
